(19) United States
(12) Patent Application Publication
(10) Pub. No.: US 2022/0393161 A1
(43) Pub. Date: Dec. 8, 2022

(54) Silicon-Sulfur-Polymer Based Composite Anodes For Lithium-Ion Batteries

(71) Applicant: NOHMS Technologies, Inc., Rochester, NY (US)

(72) Inventors: Surya S. Moganty, Henrietta, NY (US); Rutvik Vaidya, Rochester, NY (US); Yue Wu, West Henrietta, NY (US)

(21) Appl. No.: 17/805,985

(22) Filed: Jun. 8, 2022

Related U.S. Application Data
(60) Provisional application No. 63/208,317, filed on Jun. 8, 2021.
(60) Provisional application No. 63/232,322, filed on Aug. 12, 2021.

(51) Int. Cl. H01M 4/38; H01M 4/04; H01M 10/056; H01M 4/62; H01M 10/052; H01M 4/485; H01M 50/491; H01M 4/66

(52) U.S. Cl. CPC H01M 4/386; H01M 4/0404; H01M 10/056; H01M 4/622; H01M 10/052; H01M 4/485; H01M 50/491; H01M 4/661

(57) ABSTRACT

A method of making anode active material including silicon, elemental sulfur and a polymer material for an electrochemical energy storage device, includes mixing together silicon particles, elemental sulfur, and at least one polymer to form a mixture; coating the mixture onto a copper current collector to form a coated copper current collector; and subjecting the coated copper current collector to a temperature treatment. An electrochemical energy storage device includes the anode active material, cathode and electrolyte.

### CROSS REFERENCE

This application claims the benefit of the filing date of U.S. Provisional Patent Application No. 63/208,317, filed Jun. 8, 2021, and U.S. Provisional Patent Application No. 63/232,322, filed Aug. 12, 2021, which are hereby incorporated by reference in their entirety.

### FIELD

The present disclosure relates to silicon-sulfur-polymer composite anodes to improve conductivity, specific capacity, and cycle life stability, and methods for producing the high-capacity silicon-sulfur-polymer composite anodes suitable for use in electrochemical energy storage devices.

### BACKGROUND

Lithium ion (Li-ion) batteries are heavily used in consumer electronics, electric vehicles (EVs), energy storage systems (ESS) and smart grids. The energy density of Li-ion batteries is dependent at least in part on the anode and cathode materials used. Optimizing processing and manufacturing of Li-ion batteries has allowed for a 4-5% improvement in the energy density of Li-ion batteries each year, but these incremental improvements are not sufficient for reaching energy density targets of next-generation technologies. In order to reach such targets, advancements in electrode materials will be required, such as incorporating high energy-density active materials into electrodes. Recent research has focused primarily on developing high energy cathodes, with only limited research dedicated to the development of anode materials.

Recently, silicon (Si) has emerged as one of the most attractive high energy anode materials for Li-ion batteries. Silicon's low working voltage and high theoretical specific capacity of 3579 mAh/g is nearly ten times that of conventional graphite, thus resulting in increased interest. Yet despite this significant advantage, silicon anodes face several challenges associated with severe volume expansion and the resultant particle breakdown. While graphite electrodes expand 10-15% during lithium intercalation, Si electrodes expand ˜300%, causing structural degradation and instability of the solid-electrolyte-interphase (SEI) layer. This causes material pulverization and electrode delamination, resulting in loss of capacity with cycling. While it is important to have efficient binders to protect the silicon particle breakdown, a conductive pathway for ion movement is also critical to maintain capacity during cycling. Past research has focused on using conductive additives derived from carbon and graphene to resolve this issue, but still face significant challenges.

Another primary challenge in developing a high-performance silicon-based electrode is maintaining electronic conduction pathways during electrochemical cycling. Particle fracture due to volumetric expansion and contraction can disrupt conduction pathways within the electrode structure and lead to active material isolation, reducing the overall capacity of the electrode. One approach to mitigating fracture related capacity loss in silicon anodes is the use of nanometer-scale materials, as it has been shown that silicon nanoparticles smaller than 150 nm can withstand full electrochemical cycling without structural degradation. However, the synthesis of silicon nanoparticles and nano-featured materials requires complex and costly processing procedures which hinder their ability to succeed in regard to largescale implementation. While micrometer-sized silicon particles are far more economical from a bulk material standpoint, micron-silicon (μSi) electrodes require a robust composite architecture to mechanically confine the particles during fracture and maintain conduction pathways.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Described herein are various embodiments of silicon-sulfur-polymer anodes and methods of making the same.

In some embodiments, the method of making the silicon-sulfur-polymer anode generally includes the steps of mixing together silicon particles, elemental sulfur, and at least one polymer to form a mixture; coating the mixture onto a copper current collector to form a coated copper current collector; and subjecting the coated copper current collector to a temperature treatment. In some embodiments, the temperature treatment may include heating the coated copper current collector in an inert atmosphere to a temperature in the range of from about 200° C. to about 600° C.

In some embodiments, an electrochemical energy storage device generally includes an anode, a cathode, and an electrolyte. The anode may include a plurality of active material particles, elemental sulfur, and at least one polymer. The plurality of active material may be silicon particles having a particle size of between about 1 nm and about 100 μm. In some embodiments, the active material particles are encapsulated by elemental sulfur, and the at least one polymer encapsulates the sulfur-encapsulated active material particles.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a flow diagram illustrating a method of making silicon-sulfur-polymer composite anodes according to various embodiments described herein;

FIG. 2 is a schematic illustration of a silicon-sulfur-polymer composite anode according to various embodiments described herein;

FIG. 3 is a graph showing cycle life studies of Silicon-PAN and Silicon-Sulfur-PAN electrodes in coin cells; and

FIG. 4 is a graph showing the relationship between heat flow and temperature for Silicon-PAN and Silicon-Sulfur-PAN electrodes.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the technology. However, embodiments may be implemented in many different forms and should not be construed as being limited to the embodiments set forth herein. The following detailed description is, therefore, not to be taken in a limiting sense.

Described herein is a silicon-sulfur-polymer anode composite material. Active material particles include silicon. Any suitable Si-composite material can be used for the Si-composite particles included in the anode material described herein. In some embodiments, the Si-composite particles are Si-carbon composite materials, such as carbon coated Si particles. In some embodiments, silicon oxides (SiOx) are used. The Si-composite can also be an alloy of Si with inert metals or non-metals. Other examples of Si-composite materials suitable for use in the embodiments described herein are graphene-silicon composites, graphene oxide-silicon-carbon nanotubes, silicon-polypyroles, and composites of nano and micron sized silicon particles. As described previously, any combination of Si-composite materials can be used in the anode material, or just a single Si-composite material can be used. The sulfur component of the composite anode material serves as a conductive additive for silicon anode-based Li-ion batteries. These materials allow formation of conductive pathways, thus improving lithium-ion mobility. Additionally, the sulfur component (optionally in conjunction with other materials as described in further detail below) can be used to wrap the silicon active material particles. The sulfur-encapsulated active material particles can then be shielded using the polymer, such as polyacrylonitrile (PAN). In this configuration, sulfur sandwiches the silicon active material particles, and the plurality of sulfur-encapsulated active material particles are then encapsulated with PAN. Upon heat treatment, the PAN component is cyclized, and the resultant composite has elasticity and mechanical robustness.

The anode material described herein can overcome expansion and conductivity challenges of silicon-based anodes, such as by providing binders that can prevent expansion of silicon particles and conductive additives to provide a path for Li-ion mobility.

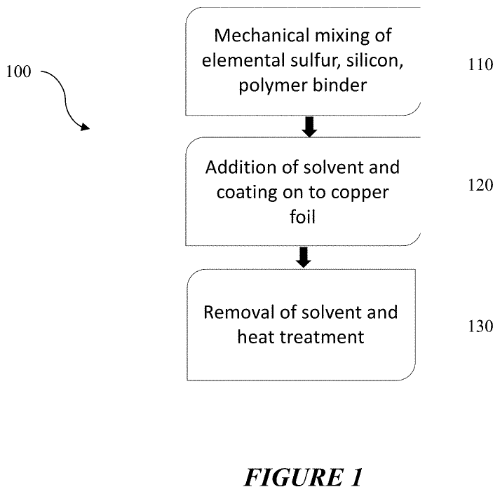

With reference to FIG. 1, a flow diagram showing an embodiment of a method 100 for preparing the composite anode material described herein generally includes step 110 of mixing together elemental sulfur, silicon and a polymer binder to form a mixture, a step 120 of adding a solvent to the mixture and coating the mixture on a copper current collector, and a step 130 of removing the solvent form the coating and subjecting the coated current collector to a heat treatment.

With respect to step 110, elemental sulfur, silicon particles and at least on polymer binder are mixed together to form a mixture. Any manner of mixing together these materials can be used, though in some embodiments, mechanical mixing is used. For example, as described in further detail in Example 1 below, the components can be mixed together by ball milling the solids at low rpm. In some embodiments, the silicon:sulfur:polymer ratio of components used in preparing the mixture of step 110 is in the range 10:1:1 to 2:1:1, such as 4:1:1.

In step 120, a solvent is added to the mixture to disperse the active materials. Any suitable solvent can be used at any suitable amount. In some embodiments, the solvent is anhydrous NMP. Other suitable solvents include, but are not limited to, N,N-dimethylformamide (DMF), dimethyl sulfone (DMSO₂), dimethyl sulfoxide (DMSO), ethylene carbonate (EC), and propylene carbonate (PC). The solvent can be mixed with the mixture of silicon, sulfur and polymer for any suitable amount of time, such as around 12 hours.

Step 120 further includes coating the slurry mixture on a current collector. The material of the current collector can be any suitable current collector material, such as copper. As discussed in Example 1 below, the coating step can be carried out using a benchtop doctor-blade coater.

In step 130, the solvent is removed from the material coated on the current collector and then the coated current collector is subject to a heat treatment. While this step is described as two separate actions, it may be possible in some embodiments to remove the solvent from the coating as part of the heat treatment step. When solvent is removed first, the solvent can be removed by heating the coating at a temperature generally below the temperature used in the subsequent heat treatment step. For example, in some embodiments, the solvent is removed from the coating by first subjecting the coated current collector to a temperature of about 60° C. (such as in a convection oven) to evaporate off the solvent.

Following solvent removal, step 130 continues with the coated current collector being subjected to a heat treatment. The heat treatment may include heating the coated current collector in an inert atmosphere to a temperature in the range of from about 200° C. to about 600° C., such as in an inert argon gas atmosphere at about 330° C. The heat treatment step is generally aimed at cyclizing the polymer component of the coating. As discussed in greater detail below, the polymer component of the coating may be PAN. Cyclization of PAN is the process when the nitrile bond (C≡N) gets converted to a double bond (C═N) due to crosslinking of PAN molecules. This step yields ladder polymer chains of PAN fiber that are elastic but mechanically robust, thus allowing for controlled fragmentation of silicon particles.

The anode composite material prepared via the methods described herein generally includes at least three materials: silicon, sulfur, and a polymer. As described in greater detail below, the anode material may include additional materials, but the sulfur, silicon and polymer are the primary ingredients of the anode composite material.

In some embodiments, the silicon is present in the anode composite material in the form of silicon particles. The size of the silicon particles can be in the range of from about 1 nm to about 100 μm. In some embodiments, the silicon particles are about 30 to 90 wt. % of the anode composite material, such as about 50 to about 80 wt. %.

The anode composite material further includes elemental sulfur. The elemental sulfur used in the formation of the anode composite material is typically provided in a powder form. In some embodiments, the sulfur is from about 0.1 wt. % to about 40 wt. % of the anode composite material.

The anode composite material further includes at least one polymer. The polymer component of the anode composite material typically serves as a binder material. In some embodiments, the at least one polymer is polyacrylonitrile (PAN). Other polymer materials may also be included in the anode composite material as needed. In some embodiments, the polymer is about 20 to about 40 wt. % of the anode composite material. As noted previously, PAN is used as a polymer binder to form elastic but robust films to allow for controlled fragmentation/pulverization of silicon particles within the binder matrix.

Other materials that may be present in the anode composite material include, but are not limited to, hard-carbon, graphite, tin, and germanium particles. When present in the anode composite material, these materials may be present in a range of from about 0.1 wt. % to about 50 wt. % of the anode composite material, such as in a range of from about 5 wt. % to about 40 wt. %.

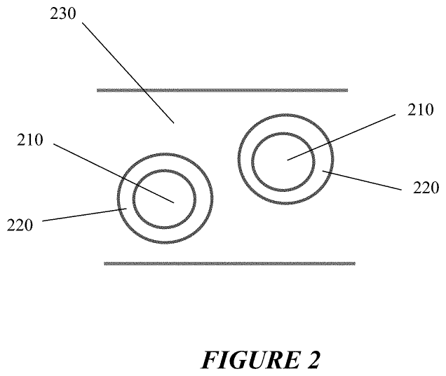

With reference to FIG. 2, the materials of the anode composite material may be arranged in a specific orientation. In some embodiments, the sulfur 220 surrounds, sandwiches, encapsulates or otherwise coats the silicon particles 210. As shown in FIG. 2, sulfur 220 surrounds one silicon particle. However, it should be appreciated that multiple silicon particles 210 could be encapsulated together by sulfur 220. As also shown in FIG. 2, the combination of silicon particles 210 encapsulated by sulfur are encapsulated or bound together by the polymer material 230. In this configuration, a plurality of sulfur-encapsulated silicon particles is dispersed throughout a polymer binder matrix to form the specific orientation of the anode composite material described herein.

The sulfur 220 surrounding the silicon particles 210 may further include additional materials, such as the hard-carbon, graphite, tin, and germanium particles mentioned previously. Thus, in some embodiments, the silicon particles 210 are surrounded by a layer of sulfur mixed with one or more of hard-carbon, graphite, tin, and germanium particles.

The anode composite material described herein can be incorporated into an electrochemical energy storage device. The electrochemical energy storage device generally includes the anode material as described herein, a cathode, and an electrolyte. In some embodiments, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery.

Suitable cathodes for use in the electrochemical energy storage device include those such as, but not limited to, a lithium metal oxide, spinel, olivine, carbon-coated olivine, LiCoO₂, LiNiO₂, LiMn_{0.5}Ni_{0.5}O₂, LiMn_{0.3}Co_{0.3}Ni_{0.3}O₂, LiMn₂O₄, LiFeO₂, LiNiₓCo_{y}Met_{z}O₂, A_{n′}B₂(XO₄)₃, vanadium oxide, lithium peroxide, sulfur, polysulfide, a lithium carbon monofluoride (also known as LiCFₓ) or mixtures of any two or more thereof, where Met is Al, Mg, Ti, B, Ga, Si, Mn or Co; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, and 0≤z≤0.5 and 0≤n′≤0.3. According to some embodiments, the spinel is a spinel manganese oxide with the formula of Li₁₊ₓMn_{2-z}Met′″_{y}O₄₋ₘX′ₙ, wherein Met″′ is Al, Mg, Ti, B, Ga, Si, Ni or Co; X′ is S or F; and wherein 0≤x≤0.3, 0≤y≤0.5, 0≤z≤0.5, 0≤m≤0.5 and 0≤n≤0.5. In other embodiments, the olivine has a formula of LiFePO₄, or Li₁₊ₓFe_{1z}Met′_{y}PO₄₋ₘX′ₙ, wherein Met″ is Al, Mg, Ti, B, Ga, Si, Ni, Mn or Co; X′ is S or F; and wherein 0≤x≤0.3, 0≤y≤0.5, 0≤z≤0.5, 0≤m≤0.5 and 0≤n≤0.5.

In an embodiment, the electrolyte component of the electrochemical energy storage device includes a) an aprotic organic solvent system; and b) a metal salt. In an embodiment, the aprotic organic solvent system is in a range of from 70% to 90% by weight of the electrolyte. In an embodiment, the metal salt is in a range of 10% to 30% by weight of the electrolyte.

In an embodiment, the aprotic organic solvent system is selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

Suitable metal salts include salts of lithium. In an embodiment, a variety of lithium salts may be used, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{10-j′}H_{j′}]; or a mixture of any two or more thereof, wherein Z is independent at each occurrence a halogen, j is an integer from 0 to 12 and j′ is an integer from 1 to 10.

In an embodiment, the anode of the electrochemical energy storage device is compatible with solid electrolytes, including organic solid electrolytes, inorganic solid electrolytes, or composite solid electrolytes (e.g., ceramic/polymer composite electrolytes). Solid electrolytes possess a much higher thermal stability than flammable liquid organic electrolytes and can work in hostile environments, such as in the temperature range from −50 to 200 degrees Celsius, by way of example, where organic electrolytes fail due to freezing, boiling, or decomposition. To achieve electrochemical performance, the solid electrolyte must demonstrate (i) high ionic conductivity; (ii) sufficient mechanical strength and few enough structural defects to prevent lithium dendrite penetration; (iii) low-cost raw resources and facile preparation processes; and (iv) low activation energy for lithium-ion diffusion. Challenges related to the use of solid electrolytes include the intrinsic features of solid-state electrolytes (i.e., the need for high ionic conductivity), the critical interfaces, and the chemo-mechanical evolution during battery manufacturing and during battery operations.

In an embodiment where the electrochemical energy storage device is a secondary battery, the secondary battery may further include a separator separating the positive and negative electrode. The separator for the lithium battery often is a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

In some embodiments the electrolyte contains an additive, such as a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof. In some embodiments, the additive is an ionic liquid. Further, the additive is present in a range of from 0.01% to 10% by weight of the electrolyte.

The disclosure will be further illustrated with reference to the following specific examples. It is understood that these examples are given by way of illustration and are not meant to limit the disclosure or the claims to follow.

### Example 1—Preparation of Silicon-Sulfur-Polymer Anodes

Active materials used were 1 μm silicon powder and elemental sulfur. These active materials were mixed with PAN polymer by ball milling the solids at low rpm, and the ratio of silicon:sulfur:polymer was 4:1:1. Anhydrous NMP was used as a solvent to disperse the active materials by mixing the slurry overnight. A benchtop doctor-blade coater was used to coat the slurry on to copper current collectors to achieve electrodes with >3 mg/cm² loading. The electrodes were then dried at 60° C. in a convection oven before heat treatment in an inert argon gas atmosphere at 330° C.

### Example 2—Preparation of Silicon-Polymer Anodes

1 μm silicon powder was used as the active material and mixed with PAN polymer by ball milling the solids at low rpm, where the ratio of silicon:polymer was 4:1. Anhydrous NMP was used as a solvent to disperse the active materials by mixing the slurry overnight. A benchtop doctor-blade coater was used to coat the slurry on to copper current collectors to achieve electrodes with >3 mg/cm′ loading. The electrodes were then dried at 60° C. in a convection oven before heat treatment in an inert argon gas atmosphere at 330° C.

### Example 3—Cell Fabrication 1

2032 coin cells were assembled with NMC811 cathode and the anode as listed in Example 1 and 2. The NMC811 cathode had ˜2.7 mAh/cm² specific capacity and ˜28 mg/cm² loading. The cathode and anode pieces were 14 mm and 15 mm respectively, and the separator used was polypropylene. 100 μl of electrolyte was used to activate the cells. Electrolyte formulations were prepared in a dry argon filled glovebox by combining all electrolyte components in glass vials by stirring for 24 hours to ensure complete dissolution of all solids. A base electrolyte formulation comprising a 3:7 by volume mixture of ethylene carbonate (EC), ethyl methyl carbonate (EMC), and 1 M lithium hexafluorophosphate (LiPF₆), as a Li⁺ ion conducting salt, dissolved therein. Additives containing carbonate functional groups and ionic liquid additives were then added to the base electrolyte formulation before cell activation.

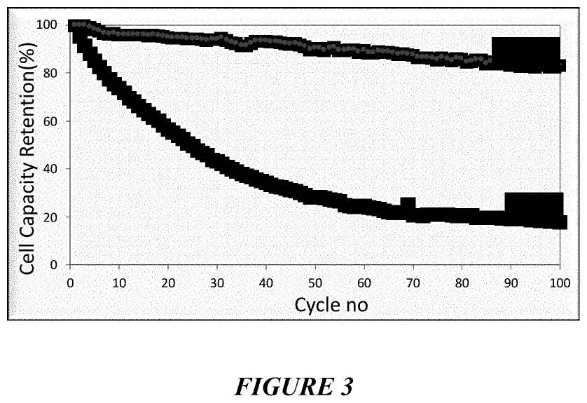

FIG. 3 is a graph showing cycle life studies of the Silicon-PAN and Silicon-Sulfur-PAN electrodes in coin cells in accordance with Examples 1-3 above. As shown in FIG. 3, cell capacity retention (%) remains higher over extended cycling for the Silicon-Sulfur PAN coin cells as compared to the Silicon-PAN coin cells.

### Example 4—DSC Data

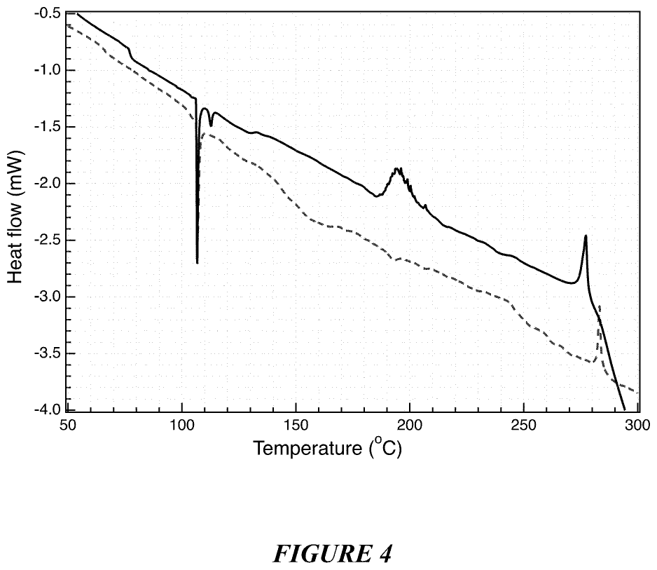

FIG. 4 is a graph showing the relationship between heat flow and temperature for Silicon-PAN and Silicon-Sulfur-PAN electrodes. Data shown in FIG. 4 was collected using differential scanning calorimetry (DSC). The addition of elemental sulfur clearly shows differences in thermal transition of PAN polymer.

### Prophetic Example 5—Cell Fabrication 2

A prophetic non-ionic liquid electrolyte is 3:7 by volume of ethylene carbonate (EC), ethyl methyl carbonate (EMC), and 1 M lithium hexafluorophosphate (LiPF₆), as a Li⁺ ion conducting salt, dissolved therein. Cyclic carbonates such as 2 wt. % vinylene carbonate (VC) and 5 wt. % fluoroethyl carbonates are added as anode SEI forming additives.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A method of making anode active material comprising silicon, elemental sulfur and a polymer material for an electrochemical energy storage device, the process comprising:
a) mixing together silicon particles, elemental sulfur, and at least one polymer to form a mixture;
b) coating the mixture onto a copper current collector to form a coated copper current collector; and
c) subjecting the coated copper current collector to a temperature treatment.

2. The method of claim 1, wherein subjecting the coated copper current collector to the temperature treatment comprises heating the coated copper current collector in an inert atmosphere to a temperature in the range of from about 200° C. to about 600° C.

3. The method of claim 1, further comprising:
after step a) and before step b), adding a solvent to the mixture to disperse the silicon particles and the at least one polymer, the solvent being selected from the group consisting of N-methyl-2-pyrrolidone (NMP), N,N-dimethylformamide (DMF), dimethyl sulfone (DMSO₂), dimethyl sulfoxide (DMSO), ethylene carbonate (EC), and propylene carbonate (PC).

4. The method of claim 3, further comprising:
after step b) and prior to step c), removing the solvent from the mixture coated on the copper current collector.

5. The method of claim 3, wherein step c) removes the solvent from the mixture coated on the copper current collector.

6. The method of claim 1, wherein the size of the silicon particles ranges from about 1 nm to about 100 μm.

7. The method of claim 1, wherein the mixture further comprises one or more of hard-carbon, graphite, tin, and germanium particles.

8. The method of claim 1, wherein the mixture comprises from 30% to 90% by weight silicon particles.

9. The method of claim 1, wherein the mixture comprises from 0.01% to 40% by weight sulfur.

10. The method of claim 1, wherein the mixture comprises from 5% to 40% by weight of the at least one polymer.

11. The method of claim 1, wherein the at least one polymer is polyacrylonitrile (PAN).

12. An electrochemical energy storage device comprising:
an anode comprising:
a plurality of active material particles, wherein each of the plurality of active material particles has a particle size of between about 1 nm and about 100 μm;
elemental sulfur; and
at least one polymer, wherein the plurality of active material particles is enclosed by the at least one polymer;
a cathode; and
an electrolyte including a) an aprotic organic solvent system and b) a metal salt.

13. The electrochemical energy storage device of claim 12, wherein the plurality of active material particles are silicon particles.

14. The electrochemical energy storage device of claim 12, wherein sulfur encapsulates one or more of the active material particles to form sulfur-encapsulated active material particles, and the at least one polymer encapsulates the sulfur-encapsulated active material particles.

15. The electrochemical energy storage device of claim 14, wherein the sulfur encapsulating one or more active material particles further includes one or more of hard-carbon, graphite, tin, and germanium particles such that the active material particles are encapsulated by sulfur and one or more of hard-carbon, graphite, tin, and germanium particles.

16. The electrochemical energy storage device of claim 12, wherein the at least one polymer comprises polyacrylonitrile.

17. The electrochemical energy storage device of claim 12, wherein the cathode comprises a lithium metal oxide, spinel, olivine, carbon-coated olivine, vanadium oxide, lithium peroxide, sulfur, polysulfide, a lithium carbon monofluoride or mixture thereof.

18. The electrochemical energy storage device of claim 12, wherein the cathode is a transition metal oxide material and comprises an over-lithiated oxide material.

19. The electrochemical energy storage device of claim 12, further comprising:
a porous separator separating the anode and the cathode from each other.

20. The electrochemical energy storage device of claim 12, wherein the metal salt includes a lithium salt.
